(19) United States
(12) Patent Application Publication
(10) Pub. No.: US 2012/0250311 A1
(43) Pub. Date: Oct. 4, 2012

(54) Mounting Bracket for Linear Fluorescent Wet Location Fixture

(76) Inventor: Jim Luegge, Minnetonka, MN (US)

(21) Appl. No.: 13/404,581

(22) Filed: Feb. 24, 2012

Related U.S. Application Data
(60) Provisional application No. 61/468,672, filed on Mar. 29, 2011.

(51) Int. Cl. F21V 5/04; F21V 31/00; F21V 17/08; F21V 21/00

(52) U.S. Cl. 362/235; 248/224.8; 29/825

(57) ABSTRACT

A mounting bracket for mounting “wet” location lighting fixtures. In embodiments, a mounting bracket allows a light fixture to be installed over a new or existing junction box. Gasketing and a plurality of bumpers provide a waterproof fit between the fixture and the junction box. In an embodiment, a lighting fixture system comprising a junction box, a lighting fixture, and a mounting bracket is presented. In another embodiment, a method of installing a lighting system to a mounting surface is presented.

### PRIORITY

This application claims priority to U.S. Provisional Application No. 61/468,672, filed Mar. 29, 2011, which is hereby incorporated in its entirety.

### FIELD OF THE INVENTION

The present invention relates generally to mounting brackets. More specifically, the present invention relates to mounting brackets for mounting “wet” location lighting fixtures.

### BACKGROUND OF THE INVENTION

Several applications, including food processing facilities, commercial kitchens, industrial facilities, pedestrian and road tunnels, laundries, saunas, elevator shafts, storage buildings, car washes, refrigerators and freezer, among others, utilize a UL Listed “wet” location lighting fixture.

Wet locations require that lighting and the corresponding mounting mechanisms that are placed within such locations to be suitably water resistant and bug resistant. Water resistant and bug resistant lighting fixtures and mounting mechanisms provide for a safe and controlled environment in which there is minimized danger of electrical shorts or bug infestation, for example, which is critical in the aforementioned applications.

Typically, traditional surface-mounted brackets do not provide water resistant and bug resistant seals between fixture boxes and lighting fixture housings. Those that do provide some sort of water-resistant or bug-resistant properties are often bulky and project the fixture far from the mounting surface. As a result, traditional methods using conduit and wire-pulling via a fixture whip and junction box cover plate are often used to mount lighting fixtures in wet locations. Such traditional methods require costly superfluous materials, such as metallic straight connectors, 90 degree connectors, liquid tight conduits, GFF series fixture mounting hardware, conduit hangers, 14 AWG THHN—Black wiring, 14 AWG THHN—White wiring, and 14 AWG THHN—Green wiring, for example.

Not only is the pure cost of materials expensive, but superfluous cost is incurred in traditional installation methods in moving all of these materials to the job site, preparing the materials for installation, and working with the materials to install lighting fixtures. The actual installation process in traditional mounting methods therefore also requires time-consuming and expensive labor costs.

Also, the look and appearance of traditional fixture whip installation methods is often unsightly and obtrusive, a consideration that should not be minimized. In lighting fixture installations using a fixture whip, the conduit or whip often runs from one end of the lighting fixture housing for a length along the ceiling or wall and finally terminating at a junction box. A junction box cover is typically used to cover the junction box and wiring within. Often, these conduits or whips and junction box covers are in a color in complete contrast to the color of the ceiling or wall (typically being available in either black or white). Alternatively, additional cost can be incurred in trying to match the color of the whip to the color of the ceiling or wall material. Additionally, whip or conduit brackets are often required to affix the whip or conduit to the ceiling or wall. Therefore, traditional installation methods provide a very cluttered and unsightly appearance proximate the installed fixture.

Further, the National Electrical Code (NEC), a United States standard for the safe installation of electrical wiring and equipment, stipulates the connection of an electric-discharge luminaire as it relates to access to boxes. Referring to §410.24(B), “Electric-discharge luminaires surface mounted over concealed outlet, pull, or junction boxes and designed not to be supported solely by the outlet box shall be provided with suitable openings in the back of the luminaire to provide access to the wiring in the box.”

Therefore, there is a need for an easily-installed and effective surface-mounting bracket for installing lighting fixtures in wet locations that is cost effective, easy to install, and in compliance with UL and National Electrical Code regulations.

### SUMMARY OF THE INVENTION

A mounting bracket according to embodiments of the present application substantially meets the aforementioned needs of the industry. The mounting bracket, according to embodiments of the invention, provides a mounting means for mounting a light fixture to a support surface in wet locations. Specifically, in embodiments, a 4-foot or 8-foot GFF series light fixture can be installed over a new or existing junction box.

In a feature and advantage of embodiments of the invention, the bracket complies with UL Listing requirements. Gasketing and a plurality of bumpers provide a waterproof fit between the fixture and the junction box. In an embodiment, neoprene closed cell foam gaskets provide water and bug resistance, thereby creating a closed environment between the fixture and the junction box. Thus, the critical area between the supply connectors and the lighting fixture is protected and power is able to pass efficiently and safely to the fixture from the junction box in wet locations. In embodiments, wet location applications therefore provide a UL listing, NEMA 4× rating, and IP67 rating that are protected against dust and the ingress of water; for example, against strong jets of directed water, and against the entry of water during prolonged submersion at a limited depth. Embodiments further protect against corrosion and against damage by the external formation of ice on any piece of the lighting system.

In another feature and advantage of embodiments of the invention, the bracket provides for an opening in the fixture and the bracket to access wiring in the junction box, in compliance with NEC §410.24(B). Therefore, embodiments are NEC compliant.

In another feature and advantage of embodiments of the invention, a simple mounting bracket eliminates the need for superfluous installation materials such as, for example, metallic straight connectors, 90 degree connectors, liquid tight conduits, GFF series fixture mounting hardware, conduit hangers, 14 AWG THHN—Black wiring, 14 AWG THHN—White wiring, and 14 AWG THHN—Green wiring of traditional fixture whip-mounted lighting fixtures. In an embodiment, 95% of the materials required in installation can be eliminated compared to traditional conduit and wire-pulling methods. Time and cost is likewise saved in not transporting the aforementioned materials to the job site, preparing the materials for installation, and working with the materials during actual installation.

Embodiments allow for much faster installation than traditional mounting means, as no fixture whips are needed to wire to the junction box from the fixture—the electrician is able to wire directly to the junction box through the fixture hole, as the fixture is positioned directly over an existing or new recessed junction box on a ceiling or wall. Additionally, the bracket provides a “snap” fit onto the fixture housing and fixture lens, further easing installation. In embodiments, no adhesive sealant or gasket is required during installation and coupling of the fixture to the mounting surface. In embodiments, a 41% material and labor savings can be realized using embodiments when compared to traditional conduit and wire method (for a 4-foot GFF series lighting fixture). An efficiently-installed and labor-saving mounting bracket is therefore provided in embodiments.

In another feature and advantage of embodiments of the invention, a clean and pleasing look is provided. Embodiments make certain types of light fixture installations much cleaner than traditional mounting means by hiding the junction box beneath the light fixture. In embodiments, no unsightly fixture whip runs from one end of the lighting fixture housing for a length along the ceiling or wall to a junction box. A pleasing look is further provided because no junction box cover plate is necessary when compared to traditional fixture whip installations. Further, there is no need to match whip colors to wall or ceiling material colors in attempt to mask the exposed whip. Likewise, no superfluous whip brackets are exposed. Therefore, only the sleek fixture lens is exposed.

Additionally, the fixture housing is mounted flush against the mounting surface, with only the thin width of the bracket material between the fixture housing between and the mounting surface, in embodiments. Therefore, embodiments of the lighting fixture only project from the mounting surface at a height of roughly the fixture height itself. The obtrusion into the area surrounding the installation location is therefore minimized. Bulky mounting brackets are therefore avoided in embodiments.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is an exploded perspective view of a lighting system depicted in conjunction with a mounting surface, according to an embodiment.

FIG. 2 is an exploded, partial sectional, side view of the lighting system of FIG. 1, depicted in conjunction with a mounting surface presented in cross section.

FIG. 3A is a perspective view of a surface mount bracket, according to an embodiment, depicted in conjunction with a mounting surface.

FIG. 3B is a perspective view of a supplemental surface mount bracket, according to an embodiment, depicted in conjunction with a mounting surface.

FIG. 4 is an exploded perspective view of a lighting system utilizing a supplemental surface mount bracket, according to an embodiment, depicted in conjunction with a mounting surface.

FIG. 5 is a sectional side view of the surface mount bracket of FIG. 3A operably coupled to a mounting surface.

FIG. 6 is a sectional side view of the supplemental surface mount bracket of FIG. 3B operably coupled to a mounting surface.

FIG. 7 is a partial sectional side view of a lighting system installed to a mounting surface, according to an embodiment.

FIG. 8 is a flow chart depicting a sequence of events for installing a fluorescent lamp with an embodiment of a mounting bracket hereof.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

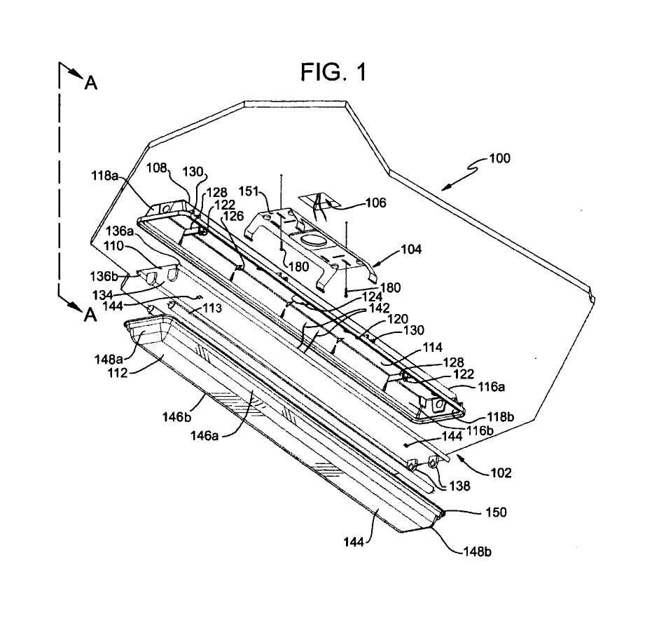

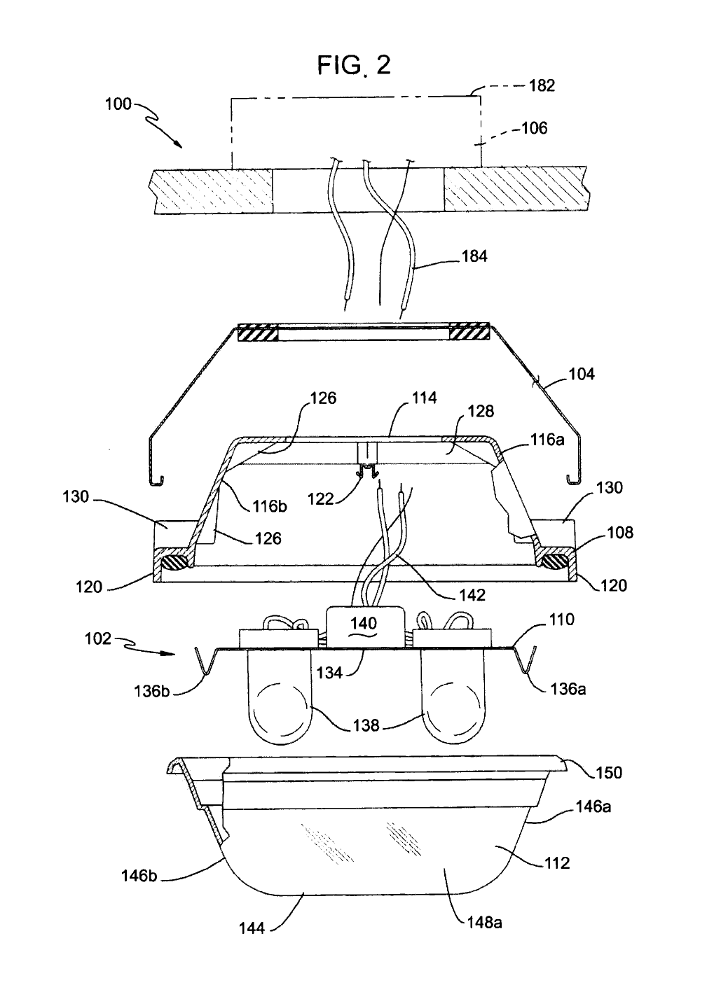

Referring generally to FIGS. 1-2, a lighting system 100 is depicted, according to an embodiment. Lighting system 100 generally includes lighting fixture 102, mounting bracket 104, and junction box 106.

Lighting fixture 102 comprises housing 108, geartray 110, lens 112, and one or more lamps 113. In an embodiment, lighting fixture 102 and its components are configured in a direction relatively orthogonal to a mounting surface, for example, along axis A of FIG. 1

Housing 108 is configured as a base to which other components of lighting fixture 102 can be coupled. Housing 108 comprises an elongated body 114, a first elongated sidewall 116a, a second elongated sidewall 116b, a first abbreviated sidewall 118a, a second abbreviated sidewall 118b, a lip 120, and one or more retaining clips 122. Elongated body 114 is substantially flat and substantially rectangular, having a length greater than a width, in an embodiment. In an embodiment, then, elongated body 114 comprises two elongated sides and two abbreviated sides and presents a longitudinal axis. Other embodiments of elongated body 114 can be more or less elongated, depending on the application and desired lighting effect. Further, the width or abbreviated side of elongated body 114 can be more or less wide, depending on the application and desired lighting effect.

One or more access apertures 124 can be configured along elongated body 114 and configured to allow access to junction box 106. As depicted in FIG. 1, access aperture 124 is circular and positioned roughly in the center of elongated body 114 and therefore, housing 108. In another embodiment, access aperture 124 can comprise a square or any other shaped void. In embodiments, access aperture 124 is not centered within elongated body 114, and is instead offset along one of the elongated sides or offset along the width elongated body 114. In embodiments, elongated body 114 can comprise a plurality of access apertures 124. In an embodiment of a 4-foot lighting fixture 102, for example, elongated body 114 comprises two access apertures 124. In an embodiment of an 8-foot lighting fixture 102, for example, elongated body 114 comprises three access apertures 124

First elongated sidewall 116a extends at an angle from elongated body 114 along one of the elongated edges of elongated body 114 for the length of elongated body 114. As depicted in FIG. 1, first elongated sidewall 116a extends at an angle greater than 90 degrees with respect to the surface of elongated body 114. However, in embodiments, first elongated sidewall 116a can extend from elongated body 114 at an angle of 90 degrees or less, depending on the application. First elongated sidewall 116a extends for a length shorter than the width of elongated body 114, although lengths of first elongated sidewall 116a that are shorter or longer than the depiction in FIG. 1 are also possible. As such, first elongated sidewall 116a is substantially rectangular. In other embodiments, first elongated sidewall 116a can be substantially trapezoidal, with non-parallel sides having the same base angles, thus creating a shape that is substantially isosceles-trapezoidal. Other differently-shaped embodiments are also considered.

Second elongated sidewall 116b extends at an angle from elongated body 114 along the elongated edge of elongated body 114 opposite first elongated sidewall 116a for the length of elongated body 114. As depicted in FIG. 1, second elongated sidewall 116b extends at an angle greater than 90 degrees with respect to the surface of elongated body 114. However, in embodiments, second elongated sidewall 116b can extend from elongated body 114 at an angle of 90 degrees or less, depending on the application. Second elongated sidewall 116b extends for a length shorter than the width of elongated body 114, although lengths of second elongated sidewall 116b that are shorter or longer than the depiction in FIG. 1 are also possible. In embodiments, as depicted, first elongated sidewall 116a and second elongated sidewall 116b extend at similar angles from their respective edges along elongated body 114 and to similar lengths, thus aiding in manufacturing. Similar to first elongated sidewall 116a, second elongated sidewall 116b can comprise substantially rectangular, trapezoidal, or isosceles-trapezoidal shapes, among others, in embodiments.

First abbreviated sidewall 118a extends at an angle from elongated body 114 along the abbreviated edge of elongated body 114 for the width of elongated body 114 to couple first elongated sidewall 116a and second elongated sidewall 116b. As depicted in FIG. 1, first abbreviated sidewall 118a extends at an angle greater than 90 degrees with respect to the surface of elongated body 114. However, in embodiments, first abbreviated sidewall 118a can extend from elongated body 114 at an angle of 90 degrees or less, depending on the application. First abbreviated sidewall 118a extends for a length shorter than the width of elongated body 114, although lengths of first abbreviated sidewall 118a that are shorter or longer than the depiction in FIG. 1 are also possible. First abbreviated sidewall 118a comprises a shape suitable to couple the interfacing edges of first elongated sidewall 116a and second elongated sidewall 116b. As such, first abbreviated sidewall 118a can comprise substantially rectangular, trapezoidal, or isosceles-trapezoidal shapes, among others, in embodiments, depending on the respective shapes of first elongated sidewall 116a and second elongated sidewall 116b.

Second abbreviated sidewall 118b extends at an angle from elongated body 114 along the abbreviated edge of elongated body 114 opposite first abbreviated sidewall 118a for the width of elongated body 114 to couple first elongated sidewall 116a and second elongated sidewall 116b at the end opposite first abbreviated sidewall 118a. As depicted in FIG. 1, second abbreviated sidewall 118b extends at an angle greater than 90 degrees with respect to the surface of elongated body 114. However, in embodiments, second abbreviated sidewall 118b can extend from elongated body 114 at an angle of 90 degrees or less, depending on the application. Second abbreviated sidewall 118b extends for a length shorter than the width of elongated body 114, although lengths of second abbreviated sidewall 118b that are shorter or longer than the depiction in FIG. 1 are also possible. In embodiments, as depicted, first abbreviated sidewall 118a and second abbreviated sidewall 118b extend at similar angles from their respective edges along elongated body 114 and to similar lengths. Likewise, second abbreviated sidewall 118b comprises a shape suitable to couple the interfacing edges of first elongated sidewall 116a and second elongated sidewall 116b at the edge of elongated body 114 opposite first abbreviated sidewall 118a. As such, second abbreviated sidewall 118b can comprise substantially rectangular, trapezoidal, or isosceles-trapezoidal shapes, among others, in embodiments, depending on the respective shapes of first elongated sidewall 116a and second elongated sidewall 116b.

The angles presented by the operable coupling of sidewalls 116a, 116b, 118a, and 118b to elongated body 114, as well as the angles presented by the coupling of first elongated sidewall 116a to first abbreviated sidewall 118a and first elongated sidewall 116a to second abbreviated sidewall 118b, and likewise the angles coupling second elongated sidewall 116b to first abbreviated sidewall 118a and second elongated sidewall 116b to second abbreviated sidewall 118b can be rounded or otherwise sloped, and need not be at discrete angles.

In an embodiment, sidewalls 116a, 116b, 118a, and 118b themselves can be angled. For example, a portion of sidewalls 116a, 116b, 118a, and 118b distal elongated body 114 can diverge from the plane of the projection from elongated body 114. In an embodiment, a portion of sidewalls 116a, 116b, 118a, and 118b extends generally orthogonal to elongated body 114. In embodiments, this can be defined as a sidewall angle.

Lip 120 comprises a projection from each of first elongated sidewall 116a, second elongated sidewall 116b, first abbreviated sidewall 118a, and second abbreviated sidewall 118b that runs along each of these aforementioned components at their respective ends distal elongated body 114. Lip 120 therefore forms a shape substantially similar to elongated body 114, but smaller or larger depending on the angle of extension of first elongated sidewall 116a, second elongated sidewall 116b, first abbreviated sidewall 118a, and second abbreviated sidewall 118b from elongated body 114. For example, if the respective angle of extension is greater than 90 degrees, the shape formed by lip 120 will be larger than the shape of elongated body 114. Conversely, if the respective angle of extension is less than 90 degrees, the shape formed by lip 120 will be smaller than the shape of elongated body 114. In an embodiment, for example as depicted in FIG. 2, lip 120 is substantially L-shaped. In embodiments therefore, lip 120 initially projects orthogonally from sidewalls 116a, 116b, 118a, and 118b, then relatively parallel to sidewalls 116a, 116b, 118a, and 118b along the angled portion of lip 120. Other shapes of lip 120 are considered, depending on the application. For example, the angle of lip 120 need not be exactly orthogonal. Further, lip 120 can comprise rounded or otherwise curved projections, or comprise a single projection that has no angle or curve whatsoever. In embodiments, lip 120 is configured to receive a corresponding lip of lens 112.

One or more retaining clips 122 are configured to operably engage housing 108. In an embodiment, a set of retaining clips 122 comprise a pair of opposing metal projections configured to hold geartray 110 in place when so engaged. As shown in FIG. 1, a first set of retaining clips 122 are positioned intermediate the length of housing 108, roughly one-third of the length of housing 108 distal first abbreviated sidewall 118a, and a second set of retaining clips 122 are positioned intermediate the length of housing 108, roughly one-third of the length of housing 108 distal second abbreviated sidewall 118b. While two pairs of retaining clips 122 are depicted at roughly one-third the length of housing 108, any number of possible pluralities or configurations of retaining clips 122 are possible. In another embodiment, one or more retaining clips 122 are not operably coupled to housing 108, but are formed as a discrete structure within housing 108 during manufacture. An individual set of retaining clips 122, comprising a pair, are configured to be squeezed or otherwise receive pressure such that each retaining clip 122 in the pair moves parallel to geartray 110 towards the other retaining clip 122 in the pair. Upon release of such pressure, the retaining clips 122 in the pair are configured to move in a direction parallel to geartray 110 away from the other retaining clip 122 in the pair.

In embodiments, housing 108 therefore comprises roughly half of an enclosed lighting fixture 102, with lens 112 providing the opposing half.

Optionally, housing 108 can comprise one or more alignment tabs 126 or 128, one or more latch-mounting members 130, and one or more latches.

Alignment tabs 126 comprise projections that extend from within the inner surface or surfaces of housing 108, for example, on elongated body 114, sidewalls 116a, 116b, 118a, or 118b, or any combination thereof. Referring to FIG. 1, for example, a series of alignment tabs 126 are configured at the angle of interface at elongated body 114 and second elongated sidewall 116b. A corresponding series of alignment tabs 126 are configured at the same relative positions along housing 108, but at the interface between second elongated sidewall 116b and lip 120. Another set of alignment tabs 126 are configured at the angle of interface at elongated body 114 and first elongated sidewall 116a, similarly with corresponding alignment tabs 126 positioned at the interface between first elongated sidewall 116a and lip 120. Such alignment tabs 126 are configured to guide geartray 110 along its edges or optionally, corresponding notches reflective of alignment tab 126 positions.

Other types of alignment tabs 128 are also considered. For example, referring again to FIG. 1, an alignment tab 128 projects directly from elongated body 114 along the width of elongated body 114, between first elongated sidewall 116a and second elongated sidewall 116b. Such alignment tabs 128 are configured to allow clearance for the various electrical and wiring components of geartray 110. Specifically, alignment tabs 128 inhibits geartray 110 from being positioned flush or too proximate elongated body 114 such that the various electrical and wiring components of geartray 110 are overly compressed or contacted. In another embodiment, alignment tabs 128 inhibits geartray 110 or any of its components from contacting housing 108 at all. In an embodiment, one or more alignment tabs 128 serve a secondary purpose as a tether cable interface point. The tether cable interface is operably couplable to one or more alignment tabs 128. For example, a clip is operably coupleable to an alignment tab 128 to subsequently be coupled to a geartray 110 tether. Other types or configurations of alignment tabs 126 or 128 are also considered, but not necessarily shown in the figures.

Latch-mounting members 130 comprise projections that extend from the outer surface or surfaces of housing 108, for example, sidewalls 116a, 116b, 118a, 118b, or lip 120. In an embodiment, a pair of proximately-positioned mounting members 130 comprise the structure for mounting a single latch. In an embodiment, referring to FIG. 1, latch-mounting members 130 are positioned along lip 120 from the edge distal elongated body 114 to, for example, first elongated sidewall 116a. A plurality of latch-mounting members 130 can be positioned along housing 108, depending on the number of latches. In FIG. 1, four sets of latch-mounting members 130 are positioned per elongated side of housing 108, for example as shown along first elongated sidewall 116a. In another embodiment, latch-mounting members 130 do not comprise projections, but a single latch-mountable structure.

One or more latches (not shown) comprise cam-type latches configured to interface and lock to lens 112. Each latch is mountable within two opposing, projecting, latch-mounting members 130. In an embodiment, latches can be made of polycarbonate that resists airborne particles. In another embodiment, latches can be made of steel or stainless steel, making such embodiments ideal for food processing facilities, freezer applications having extreme temperatures, and livestock containment buildings having acidic conditions.

In an embodiment, housing 108 and its subcomponents can be made of stainless steel. In another embodiment, housing 108 can be made of reinforced polyester. In another embodiment, housing 108 can be made of plastic. In embodiments, solid housing 108 provides strong rigidity with no or limited deflection.

Geartray 110 comprises a body 134, first lip 136a, second lip 136b, one or more lampholder projections 138, one or more ballasts 140, and fixture wiring 142.

Body 134 is substantially flat and substantially rectangular, having a length greater than a width, in an embodiment. Other embodiments of body 134 can be more or less elongated, depending on the application and desired lighting effect. Further, the width of body 134 can be more or less wide, depending on the application and desired lighting effect. In embodiments, body 134 of geartray 110 is slightly smaller than the side of housing 108 in order to accommodate geartray 110 into housing 108. Likewise, the shape of body 134 is dictated by the shape of housing 108, and specifically, elongated body 114. In an embodiment, body 134 can be made of corrosion-protected metal or other suitable materials.

One or more retaining clip apertures 144 are configured along body 134. An individual retaining clip aperture 144 is of a size such that retaining clip 122 is designed to fit within an individual retaining clip aperture 144 when lighting fixture 102 is assembled, yet keeping the continuity of body 134 as contiguous as possible. For example, retaining clip aperture 144 can comprise a slit or slot slightly larger than the size of retaining clip 122. Retaining clip apertures 144, in an embodiment, are positioned as pairs of apertures along body 134 at the relative location along lighting fixture 102 as retaining clips 122 are along housing 108. For example, referring to the depiction of an embodiment in FIG. 1, a first set of retaining clip apertures 144 are positioned intermediate the length of body 134, roughly one-third of the length of body 134 distal a first end corresponding to that proximate first abbreviated sidewall 118a when assembled, and a second set of retaining clip apertures 144 are positioned intermediate the length of body 134, roughly one-third of the length of body 134 distal a second end corresponding to that proximate second abbreviated sidewall 118b when assembled. One or more retaining clip apertures 144 therefore allow one or more retaining clips 122 to project through body 134 to be accessible to a user.

First lip 136a comprises, in an embodiment, a substantially V-shaped projection that extends along one of the elongated edges of body 134 for the length of body 134. In an embodiment, first lip 136a extends from body 134 such that the arc created by the two rays of first lip 136a, as connected by a vertex, is substantially in the same plane as body 134. Other shapes of first lip 136a are considered, depending on the application. For example, the angle of first lip 136a need not be V-shaped. Further, first lip 136a can comprise rounded or otherwise curved projections, or comprise a single projection that has no angle or curve whatsoever. First lip 136a is configured to interface with lip 120 of housing 108, as well as lens 112.

Second lip 136b comprises, in an embodiment, a substantially V-shaped projection that extends along the elongated edge of body 134 opposite first lip 136a for the length of body 134. Similar to first lip 136a, in an embodiment, second lip 136b extends from body 134 such that the arc created by the two rays of second lip 136b, as connected by a vertex, is substantially in the same plane as body 134. Other shapes of second lip 136b are considered, depending on the application and likewise, the shape of first lip 136a. First and second lips 136a and 136b can comprise the same shape, or shapes different than the other, in embodiments.

Body 134, first lip 136a, and second lip 136b can be made of, for example, stainless steel, or reinforced polyester, in embodiments. Other non-conductive, insulative, or semi-conductive materials can comprise body 134, first lip 136a, and second lip 136b.

Lampholder projection 138 comprises a semicircle or semi-ovular projection from body 134 configured to apply electrical current to lamp 113. In an embodiment, a first lampholder projection 138 is positioned at a first end of body 134, and a second lampholder projection 138 is positioned at a second end opposite the first end at the length of body 134 to comprise a set or pair. The set or pair of lampholder projections 138 is thus configured to operably couple to and power a single lamp 113. In the embodiment depicted in FIG. 1, a first set of lampholder projections 138 is positioned proximate first lip 136a, and a second set of lampholder projections 138 is positioned proximate second lip 136b. Myriad different positionings and pluralities of sets are considered. Further, in an embodiment, lampholder projections 138 need not be in pairs, but comprise a single projection configured to hold lamp 113 in a cantilevering manner.

Ballast 140 limits the amount of current in the circuit created by the lighting system 100. In an embodiment, ballast 140 comprises an inductive ballast that limits the current through the lamps 113, which can otherwise rise to harmful levels. As such, ballast 140 is operably coupled to fixture wiring 142 and through to one or more lamps 113. In an embodiment, ballast 140 is operably coupled to body 134. As depicted in FIG. 2, ballast 140 is positioned on body 134 on the side opposite lampholder projections 138. In other embodiments, ballast 140 can be positioned and affixed on the side of lampholder projections 138, or can be free from body 134.

Fixture wiring 142 comprises the wiring adapted to couple the supply conductors from junction box 106 to ballast 140 and lamps 113. Fixture wiring 142 therefore comprises wiring coupling ballast 140 to one or more lamps 113, and through the electrical contacts of lampholder projections 138, in an embodiment. In an embodiment, fixture wiring 142 comprises a luminaire disconnect configured to couple junction box 106 supply connectors to ballast 140. In an embodiment, the luminaire disconnect is yellow and color coded for circuit wiring. In an embodiment, the termination of hot supply line conductors are connected to a black port and a neutral conductor is connected to white, while a green ground is connected to a green bonding pigtail to the underside of geartray 110. Such a configuration maintains correct polarity from junction box 106 to lamps 113.

Optionally, geartray 110 comprises a tether (not shown) that is operably coupled to body 134, first lip 136a, or second lip 136b, or some combination thereof. The tether can comprise an extension of wiring, string, or other material that can be coupled to housing 108 to retain geartray 110 near housing 108. Such a configuration simplifies installation and allows for easy ballast 140 replacement.

Lens 112 comprises a lens elongated body 144, a lens first elongated sidewall 146a, a lens second elongated sidewall 146b, a lens first abbreviated sidewall 148a, a lens second abbreviated sidewall 148b, and a lens lip 150.

Lens elongated body 144 is substantially flat and substantially rectangular, having a length greater than a width, in an embodiment. Other embodiments of lens elongated body 144 can be more or less elongated, depending on the application and desired lighting effect. Further, the width of lens elongated body 144 can be more or less wide, depending on the application and desired lighting effect.

Lens first elongated sidewall 146a extends at a rounded angle from lens elongated body 144 along one of the elongated edges of lens elongated body 144 for the length of lens elongated body 144. As depicted in FIG. 1, lens first elongated sidewall 146a extends at a rounded angle greater than 90 degrees with respect to the surface of lens elongated body 144. However, in embodiments, lens first elongated sidewall 146a can extend from lens elongated body 144 at an angle of 90 degrees or less, depending on the application. Lens first elongated sidewall 146a extends for a length shorter than the width of lens elongated body 144, although lengths of lens first elongated sidewall 146a that are shorter or longer than the depiction in FIG. 1 are also possible. As such, first elongated sidewall 116a is substantially rectangular. In other embodiments, lens first elongated sidewall 146a can be substantially trapezoidal, with non-parallel sides having the same base angles, thus creating a shape that is substantially isosceles-trapezoidal. Other differently-shaped embodiments are also considered. Additionally, the outer surface of lens first elongated sidewall 146a can be ridged or otherwise stepped to create a different diffusion appearance.

Lens second elongated sidewall 146b extends at a rounded angle from lens elongated body 144 along the elongated edge of lens elongated body 144 opposite lens first elongated sidewall 146a for the length of lens elongated body 144. As depicted in FIG. 1, lens second elongated sidewall 146b extends at a rounded angle greater than 90 degrees with respect to the surface of lens elongated body 144. However, in embodiments, lens second elongated sidewall 146b can extend from lens elongated body 144 at an angle of 90 degrees or less, depending on the application. Lens second elongated sidewall 146b extends for a length shorter than the width of lens elongated body 144, although lengths of lens second elongated sidewall 146b that are shorter or longer than the depiction in FIG. 1 are also possible. In embodiments, as depicted, lens first elongated sidewall 146a and lens second elongated sidewall 146b extend at similar angles from their respective edges along lens elongated body 144 and to similar lengths, thus aiding in manufacturing. Similar to lens first elongated sidewall 146a, lens second elongated sidewall 146b can comprise substantially rectangular, trapezoidal, or isosceles-trapezoidal shapes, among others, in embodiments. Further, the outer surface of lens second elongated sidewall 146b can be ridged or otherwise stepped, as in lens first elongated sidewall 146a.

Lens first abbreviated sidewall 148a extends at a rounded angle from lens elongated body 144 along the abbreviated edge of lens elongated body 144 for the width of lens elongated body 144 to couple lens first elongated sidewall 146a and lens second elongated sidewall 146b. As depicted in FIG. 1, lens first abbreviated sidewall 148a extends at a rounded angle greater than 90 degrees with respect to the surface of lens elongated body 144. However, in embodiments, lens first abbreviated sidewall 148a can extend from lens elongated body 144 at an angle of 90 degrees or less, depending on the application. Lens first abbreviated sidewall 148a extends for a length shorter than the width of lens elongated body 144, although lengths of lens first abbreviated sidewall 148a that are shorter or longer than the depiction in FIG. 1 are also possible. Lens first abbreviated sidewall 148a comprises a shape suitable to couple the interfacing edges of lens first elongated sidewall 146a and lens second elongated sidewall 146b. As such, lens first abbreviated sidewall 148a can comprise substantially rectangular, trapezoidal, or isosceles-trapezoidal shapes, among others, in embodiments, depending on the respective shapes of lens first elongated sidewall 146a and lens second elongated sidewall 146b. The outer surface of lens first abbreviated sidewall 148a can be ridged or otherwise stepped.

Lens second abbreviated sidewall 148b extends at a rounded angle from lens elongated body 144 along the abbreviated edge of lens elongated body 144 opposite lens first abbreviated sidewall 148a for the width of lens elongated body 144 to couple lens first elongated sidewall 146a and lens second elongated sidewall 146b at the end opposite lens first abbreviated sidewall 148a. As depicted in FIG. 1, lens second abbreviated sidewall 148b extends at an angle greater than 90 degrees with respect to the surface of lens elongated body 144. However, in embodiments, lens second abbreviated sidewall 148b can extend from lens elongated body 144 at an angle of 90 degrees or less, depending on the application. Lens second abbreviated sidewall 148b extends for a length shorter than the width of lens elongated body 144, although lengths of lens second abbreviated sidewall 148b that are shorter or longer than the depiction in FIG. 1 are also possible. In embodiments, as depicted, lens first abbreviated sidewall 148a and lens second abbreviated sidewall 148b extend at similar angles from their respective edges along lens elongated body 144 and to similar lengths. Likewise, lens second abbreviated sidewall 148b comprises a shape suitable to couple the interfacing edges of lens first elongated sidewall 146a and lens second elongated sidewall 146b at the edge of lens elongated body 144 opposite lens first abbreviated sidewall 148a. As such, lens second abbreviated sidewall 148b can comprise substantially rectangular, trapezoidal, or isosceles-trapezoidal shapes, among others, in embodiments, depending on the respective shapes of lens first elongated sidewall 146a and lens second elongated sidewall 146b. The outer surface of lens second abbreviated sidewall 148b can be ridged or otherwise stepped.

Lens lip 150 comprises a projection from each of lens first elongated sidewall 146a, lens second elongated sidewall 146b, lens first abbreviated sidewall 148a, and lens second abbreviated sidewall 148b that runs along each of these aforementioned components at their respective ends distal lens elongated body 144. Lens lip 150 therefore forms a shape substantially similar to lens elongated body 144, but smaller or larger depending on the angle of extension of lens first elongated sidewall 146a, lens second elongated sidewall 146b, lens first abbreviated sidewall 148a, and lens second abbreviated sidewall 148b from lens elongated body 144. For example, if the respective angle of extension is greater than 90 degrees, the shape formed by lens lip 150 will be larger than the shape of lens elongated body 144. Conversely, if the respective angle of extension is less than 90 degrees, the shape formed by lens lip 150 will be smaller than the shape of lens elongated body 144. In an embodiment, for example as depicted in FIG. 2, lens lip 150 is rounded. In embodiments therefore, lens lip 150 projects from sidewalls 116a, 116b, 118a, and 118b, outward and sloping back towards lens elongated body 144, then parallel with sidewalls 116a, 116b, 118a, and 118b. Other shapes of lens lip 150 are considered, depending on the application. For example, lens lip 150 need not rounded or curved; orthogonal configurations are also considered. Lens lip 150 can also comprise a single projection that has no angle or curve whatsoever. In embodiments, lens lip 150 is configured to interface with lip 120 of housing 108.

Lens 112 and its components can be made of acrylic to form an acrylic ribbed diffuser, in an embodiment. In another embodiment, lens 112 can be made of acrylic to form an acrylic clear diffuser, in both a basic and a wide specular reflector option.

One or more lamps 113 can comprise fluorescent bulbs, in an embodiment. In embodiments, lamps 113 T5 and T8 bulbs having long life and energy efficiency with uniform lumen distribution. Lamps 113 are configured to be operably coupled to opposing one or more lampholder projections 138. In embodiments, lamps 113 can number one, two, three, four, or more in an individual housing (and corresponding geartray 110). Lamps 113 can be, for example, 4-feet in embodiments. In another embodiment, lamps 113 can be 8-feet in embodiments.

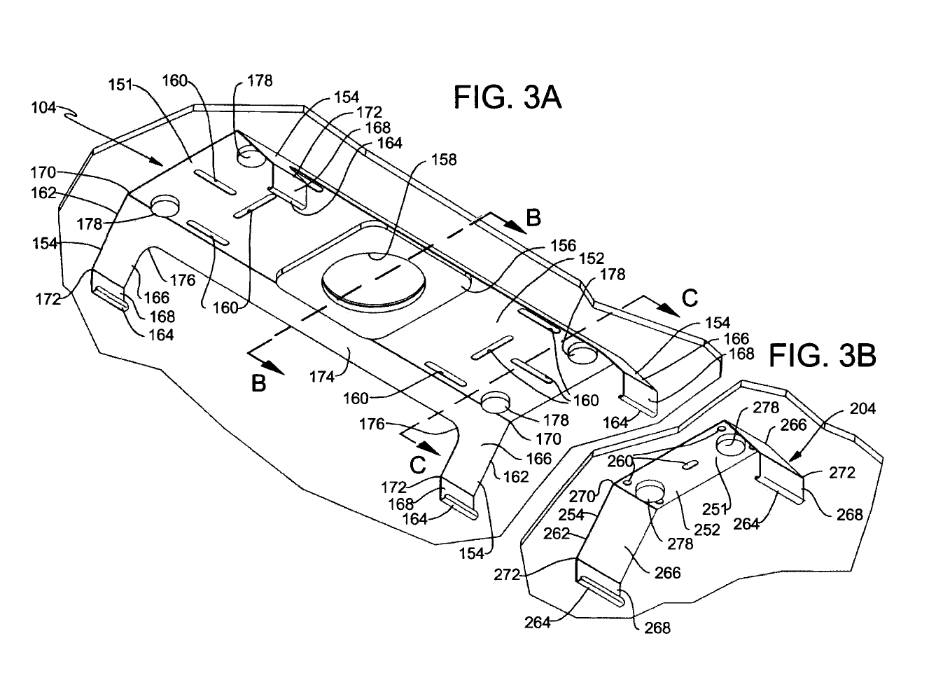

Referring to FIG. 3A, Mounting bracket 104 generally comprises a mounting plate 151 having a main surface 152, a plurality of mounting bracket clips 154, and one or more gaskets 156. Mounting bracket 104 is configured to engage housing 108 and/or lens 112, or any combination thereof, to provide positive, resilient engagement of light fixture 102.

Main surface 152 is substantially flat and substantially rectangular, having a length greater than a width, in an embodiment. Main surface 152 is configured to mirror the relative shape of housing 108, and specifically, elongated body 114. In an embodiment, then, main surface 152 comprises two elongated sides and two abbreviated sides and is configured to abut the longitudinal axis of elongated body 114. Other embodiments of main surface 152 can be more or less elongated, depending on the shape of elongated body 114. Further, the width or abbreviated sides of main surface 152 can be more or less wide, depending on the shape of elongated body 114. Of course, main surface 152 can comprise any number of shapes and sizes, and need not exactly mirror the shape of elongated body 114. As depicted in FIG. 1, main surface 152 is of a length much less than the length of housing 108. However, main surface 152 can comprise a longer relative portion of housing 108, in embodiments.

Main surface 152 comprises one or more wiring apertures 158. As depicted in FIG. 3A, wiring aperture 158 is circular and positioned roughly in the center of main surface 152 along, for example, along an axis B through main surface 152. Wiring aperture 158 is configured to mirror the relative shape of access aperture 124. Therefore, in another embodiment, wiring aperture 158 can comprise a square or any other shaped void. In embodiments, wiring aperture 158 is not centered within main surface 152, and is instead offset along one of the elongated sides or offset along the width of main surface 152. Similarly, in embodiments, main surface 152 can comprise a plurality of wiring apertures 158.

Main surface 152 further comprises a plurality of coupling apertures 160. Coupling apertures 160 are configured to receive a fastener for securing mounting bracket 104. In an embodiment, for example, that depicted in FIG. 3A, coupling apertures 160 are of a type of slotted aperture. In embodiments, coupling apertures 160 can be of a shape other than a slot, for example, a circular void or any other suitable shape.

Coupling apertures 160 can be configured in myriad positions relative to main surface 152. In an embodiment, coupling apertures 160 can be positioned with the lengthwise opening of the slot parallel with an elongated side of main surface 152. In another embodiment, coupling apertures 160 can be orthogonal to an elongated side of main surface 152. In another embodiment, main surface 152 can comprise some coupling apertures 160 running parallel to an elongated side of main surface 152, and others running orthogonal to an elongated side of main surface 152. Of course, in embodiments, coupling apertures 160 need not be perfectly parallel or orthogonal to an elongated side of main surface 152. In another embodiment, two coupling apertures 160 intersect to form an X or cross shape. In other embodiments, two or more coupling apertures 160 intersect to form other aperture shapes.

In an embodiment, a plurality of coupling apertures 160 are configured on a single main surface 152, having for example, eight coupling apertures 160. As depicted in FIG. 3A, on one side of main surface 152, three coupling apertures 160 are configured parallel to an elongated side of main surface 152, and one coupling apertures 160 is configured orthogonal to an elongated side of main surface 152. That configuration is mirrored on the opposing side of main surface 152. In embodiments, there can be more or less coupling apertures 160 per main surface 152, depending on the application of lighting system 100 and the mounting surface.

In an embodiment, referring to FIG. 3A, each elongated side of main surface 152 comprises two mounting bracket clips 154. A first mounting bracket clip 154 is positioned along the first elongated side at a location proximate the first abbreviated side, for example, proximate an axis C through main surface 152. A second mounting bracket clip 154 is positioned along the first elongated side at a location proximate the second abbreviated side, therefore distal the first mounting bracket clip 154 along the main surface 152 first elongated side. Similarly, a third mounting bracket clip 154 is positioned along the second elongated side at a location proximate the first abbreviated side, for example, along an axis C through main surface 152. A fourth mounting bracket clip 154 is positioned along the second elongated side at a location proximate the second abbreviated side, therefore distal the third mounting bracket clip 154 along the main surface 152 second elongated side.

Each of a plurality of mounting bracket clips 154 generally comprises a leg 162 and a hook 164. Leg 162, in an embodiment, comprises a first portion 166 and a second portion 168, with an angle of projection 170 presented at the junction between first portion 166 and main body 152, and an angle of extension 172 presented at the junction of first portion 166 and second portion 168.

First portion 166 is operably coupled to main surface 152 and projects at an angle of projection 170 from main surface 152. Similar to the angle of attachment of first and second elongated sidewalls 116a and 116b to elongated body 114, the angle of projection 170 of first portion 166 can be greater than 90 degrees with respect to the main surface 152. However, in embodiments, angle of projection 170 from main surface 152 can be at an angle of 90 degrees or less, depending on the application. Angle of projection 170 generally mirrors the angle of attachment of first elongated sidewall 116a to elongated body 114 and second elongated sidewall 116b to elongated body 114. Angle of projection 170 need not perfectly mirror the angle of attachment of first and second elongated sidewalls 116a and 116b, in embodiments, but, as depicted for example, in FIG. 6, can be such that the respective first portions 166 of each leg 162 are flush with first and second elongated sidewalls 116a and 116b.

First portion 166 extends for a length similar to that of the projection of first or second elongated sidewalls 116a and 116b from elongated body 114, in an embodiment. The length of first portion 166 is configured to interface with first or second elongated sidewalls 116a and 116b. As such, first portion 166 can be elongated or shortened, depending on the relative projection of first or second elongated sidewalls 116a and 116b from elongated body 114. As described above with respect to first and second elongated sidewalls 116a and 116b, first portion 166 can extend for a length shorter than the width of main surface 152, although lengths of first portion 166 that are shorter or longer than the depiction in FIGS. 1-3A are also possible. First portion 166 can be substantially rectangular, in embodiments.

Second portion 168 extends from first portion 166. The junction between first portion 166 and second portion 168 creates an angle of extension 172 that mirrors the extension of lip 120 from housing 108, and specifically, the extension of lip 120 from first elongated sidewall 116a and second elongated sidewall 116b. In an embodiment, angle of extension 172 can be greater than 90 degrees with respect to first portion 166. However, in embodiments, angle of extension 172 from first portion 166 can be at an angle of 90 degrees or less, depending on the application. As depicted in FIG. 2, second portion 168 is orthogonal to main surface 152, thus creating an angle of extension 172 that is greater than 90 degrees relative to first portion 166.

Second portion 168 extends for a length similar to that of the length of lip 120, in an embodiment. Second portion 168 is therefore configured to interface with any extension of housing 108 beyond first or second elongated sidewalls 116a and 116b. As such, second portion 168 can be elongated or shortened, depending on the relative projection of housing 108 past the termination of sidewalls 116a and 116b. First portion 166 can be substantially rectangular, in embodiments.

In an embodiment, individual legs 162, and specifically, individual first portions 166 can be connected by supporting member 174 as depicted in FIG. 3A, but can also be directly coupled to main surface 152 in other embodiments. Supporting member 174 can span the relative length of an elongated side of main surface 152 that is not spanned by each leg 162 and specifically, each first portion 166 so as to couple individual legs 162 on the same side, together. Supporting member 174 can have a similar or identical angle of projection 170 as that of first portion 166 with main surface 152. Supporting member 174 can likewise extend from main surface 152 up to or longer than the extension of first portion 166 from main surface 152.

In an embodiment, an angle of connection 176 is created between first portion 166 and supporting member 174. Angle of connection 176 can provide additional stability to individual legs 162, depending on its measure. Angle of connection 176 between first portion 166 and supporting member 174 can be relatively rounded, as depicted in FIG. 3A, but can be at sharp angles, in embodiments. The greater the relative angle of angle of connection 176, the more support to individual legs 162 is provided, until reaching a maximum point of a straight connection between, for example, the junction of angle of extension 172, and the relative intermediate point of supporting member 174 along an elongated side of main surface 152. Angle of connection 176 can therefore be varied, depending on the embodiment.

Hook 164 is located at a distal end of leg 162, and specifically, the end of second portion 168 distal the end of second portion 168 that extends from first portion 166. Hook 164 extends back toward main surface 152, in an embodiment. As such, hook 164 is configured to interface with lip 120. In an embodiment, a portion of housing 108, and likely lip 120 can be encompassed on two sides by hook 164 when so interfaced. In another embodiment, hook 164 extends back towards main surface 152, and then orthogonal to the extension towards main surface 152, such that a portion of hook 164 extends relatively parallel to second portion 168. In an embodiment, a portion of housing 108, and likely lip 120, can be encompassed on three sides by hook 164 when so interfaced.

Mounting bracket 104 and its components can be made of can be made of, for example, stainless steel, reinforced polyester, or any non-conductive, insulative, or semi-conductive material or combination of materials. In embodiments, mounting bracket 104 is made of corrosion-protected metal.

Gasket 156 comprises a ring gasket operably coupled to main surface 152 in a ring surrounding wiring aperture 158. Gasket 156 can span any length of main surface 152 surrounding wiring aperture 158, as appropriate. Gasket 156 has a depth that is compressible and configured to interface to the surface of housing 108, and specifically elongated body 114. Gasket 156 is therefore configured to provide a seal between the mounting surface, the surface of main surface 152, and the surface of housing 108, and specifically elongated body 114. Such a seal protects wiring aperture 158 and the wiring passing therethrough. In an embodiment, as depicted in FIG. 3A, gasket 156 comprises a substantially rectangular gasket. In embodiments of main surface 152 having multiple wiring apertures 158, multiple gaskets 156 can likewise be operably coupled to main surface 152. Gasket 156 can be made of, for example, neoprene closed cell foam, or any other water-repelling foam, sponge, rubber, or other suitable material. In embodiments, gasket 156 can be made of any other suitable UL approved or tested material.

Optionally, one or more bumpers 178 can be positioned along main surface 152. In an embodiment, bumpers 178 are circular, as depicted in FIG. 3A. In other embodiments, bumpers 178 can be any other shape suitable for the relative main surface 152 to which they are mounted, and for the relative application in which mounting bracket 104 is placed. Each bumper 178 has a depth similar to that of gasket 156 that is compressible and configured to interface to the surface of housing 108, and specifically elongated body 114. Because, in embodiments, bumpers 178 are spread along the length of main surface 152, a relatively uniform compression is achieved when main surface 152 is interfaced with elongated body 114. Bumpers 178 can be made of, for example, neoprene closed cell foam, or any other water-repelling foam, sponge, rubber, or other suitable material. Bumpers 178 can also be identified as supporting gaskets.

Optionally, mounting bracket 104 can further comprise one or more fasteners 180 and related mounting hardware. Fasteners 180 and mounting hardware are configured to be received by coupling apertures 160 through main surface 152 and into a mounting surface to secure mounting bracket 104 to the mounting surface. For example, referring to FIG. 1, fastener 180 can comprise a screw. Other fasteners are also considered. In embodiments, mounting hardware can further comprise a washer to interface with a portion of main surface 152, and specifically, the portion proximate an individual coupling aperture 160 to which fastener 180 is positioned through.

Junction box 106 comprises a frame 182 and a plurality of supply conductors 184. Frame 182 comprises a box or walled container configured to contain supply conductors 184 and other electrical connections. Frame 182 can therefore comprise any number of shapes. For example, as depicted in FIGS. 2, 5, and 6, junction box 106 comprises a square or rectangular container. In another embodiment, junction box 106 can comprise a circularly-walled container. In embodiments, junction box 106 can be made of metal or plastic. In an embodiment, junction box 106 can be recessed in a ceiling or wall, or other mounting surface, such that the mounting surface substantially covers the walls of junction box 106, but is open or apertured where supply conductors 184 are positioned within. Supply conductors 184 comprise wiring that is configured to carry electric charges. As such, supply conductors 184 are operably coupled to a power supply configured with appropriate power to light one or more lamps 113.

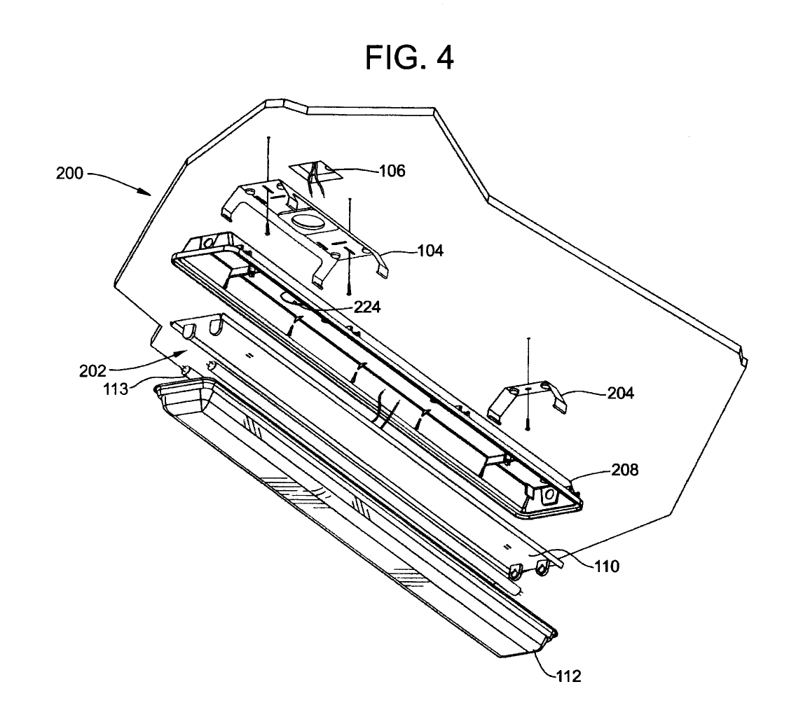

In another embodiment, referring to FIGS. 3B and 4, a lighting system 200 generally includes mounting bracket 104, lighting fixture 202, supplemental mounting bracket 204, and junction box 206.

Lighting fixture 202 comprises housing 208, geartray 110, lens 112, and one or more lamps 113. Lighting fixture 202 is substantially the same as lighting fixture 102, with differences described herein. Specifically, lighting fixture 202 comprises an offset access aperture 224 within elongated body 214 of housing 208, as described above with respect to housing 108.

Supplemental mounting bracket 204 can provide additional support for certain lighting fixtures 202 and lighting systems 200 when used alone or in combination with mounting bracket 104. Supplemental mounting bracket 204 generally comprises a mounting plate 251 having a main surface 252, mounting bracket clip 254, and one or more optional bumpers 278. Additionally, supplemental mounting bracket 204 can optionally comprise one or more fasteners 280.

Main surface 252 is substantially the same as main surface 152, but adapted to be of a size appropriate for supplemental mounting bracket 204. Main surface 252 is substantially flat and substantially rectangular. In an embodiment, as depicted in FIG. 3B, main surface has a having a width greater than a length, according to the same measuring style of main surface 152, in an embodiment. Main surface 252 is configured to mirror the relative shape of housing 208, and specifically elongated body 214. Other embodiments of main surface 252 can be more or less elongated, depending on the shape of elongated body 214. Further, the width sides of main surface 252 can be more or less wide, depending on the shape of elongated body 214. Of course, main surface 252 can comprise any number of shapes and sizes, and need not exactly mirror the shape of elongated body 214. As depicted in FIG. 3B, main surface 252 is of a length much less than the length of housing 208. However, main surface 252 can comprise a longer relative portion of housing 208, in embodiments.

Main surface 252 further comprises a plurality of coupling apertures 260. Coupling apertures 260 are substantially the same as coupling apertures 260, but are configured to receive a fastener for securing supplemental mounting bracket 204. In an embodiment, for example, that depicted in FIG. 3B and in the center of main surface 252, coupling apertures 260 are of a type of slotted aperture. In embodiments, coupling apertures 260 can be of a shape other than a slot, for example, a circular void or any other suitable shape, such as those in the relative corners of main surface 252.

Coupling apertures 260 can be configured in myriad positions relative to main surface 252. In an embodiment, coupling apertures 260 can be positioned in the center of main surface 252. In another embodiment, coupling apertures 260 can be positioned in the relative corners of main surface 252. In other embodiments, coupling apertures 260 can slotted apertures parallel or orthogonal to a side of main surface 252, or comprise X or cross shaped apertures, as described above with respect to main surface 152.

In an embodiment, a plurality of coupling apertures 260 are configured on a single main surface 252, having for example, five coupling apertures 260, as depicted in FIG. 3B. In embodiments, there can be more or less coupling apertures 260 per main surface 252, depending on the application of lighting system 200 and the mounting surface.

Mounting bracket clip 254 is substantially the same as mounting bracket clip 154. Supplemental mounting bracket 204 therefore comprises two mounting bracket clips 254. A first mounting bracket clip 254 is positioned along a side corresponding to an elongated side of housing 208, and a second mounting bracket clip 254 is positioned along the opposing elongated side of housing 208.

Mounting bracket clip 254 generally comprises a leg 262 substantially the same leg 162 and a hook 264 substantially the same as hook 164. Leg 262, in an embodiment, comprises a first portion 266 substantially the same as first portion 166 and a second portion 268 substantially the same as second portion 168, with an angle of projection 270 at the junction between first portion 266 and main body 252 substantially the same as angle of projection 170, and an angle of extension 272 at the junction of first portion 266 and second portion 268 substantially the same as angle of extension 172.

One or more bumpers 278 substantially the same as bumpers 178 can be positioned along main surface 252. Just as with bumpers 178, bumpers 278 can be circular, in an embodiment, as depicted in FIG. 3B.

Each bumper 278 has a depth similar to that of gasket 156 and bumper 178 that is compressible and configured to interface to the surface of housing 208, and specifically elongated body 214. Bumpers 278 therefore allow supplemental mounting bracket 204 to be coupled at the same distance relative to housing 208 as mounting bracket 104, because the same depth of material is interfaced between main surface 152 and housing 208 as is main surface 252 with housing 208. Bumpers 278 can be made of, for example, neoprene closed cell foam, or any other water-repelling foam, sponge, rubber, or other suitable material.

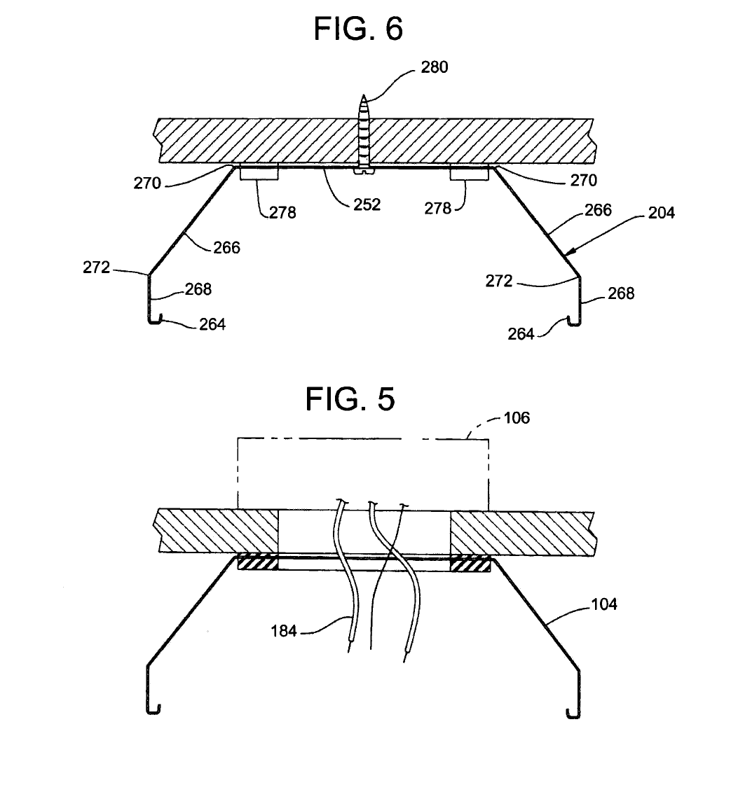

Optionally, supplemental mounting bracket 204 can further comprise one or more fasteners 280 and related mounting hardware. Fasteners 280 and related mounting hardware are substantially the same as fasteners 180, and are configured to be received by coupling apertures 260 through main surface 252 and into a mounting surface to secure supplemental mounting bracket 204 to the mounting surface. For example, referring to FIG. 5, fastener 280 can comprise a screw. Other fasteners are also considered. In embodiments, mounting hardware can further comprise a washer to interface with a portion of main surface 252, and specifically, the portion proximate an individual coupling aperture 260 to which fastener 280 is positioned through.

Junction box 206 is substantially the same as junction box 106, with differences described herein. Specifically, junction box 106 is positioned at a location within the mounting surface such that it is near a wall or other obstruction, for example. In such an embodiment, lighting fixture 202 may not be able to be centered on mounting bracket 104, and instead is mounted to one side of lighting fixture 202.

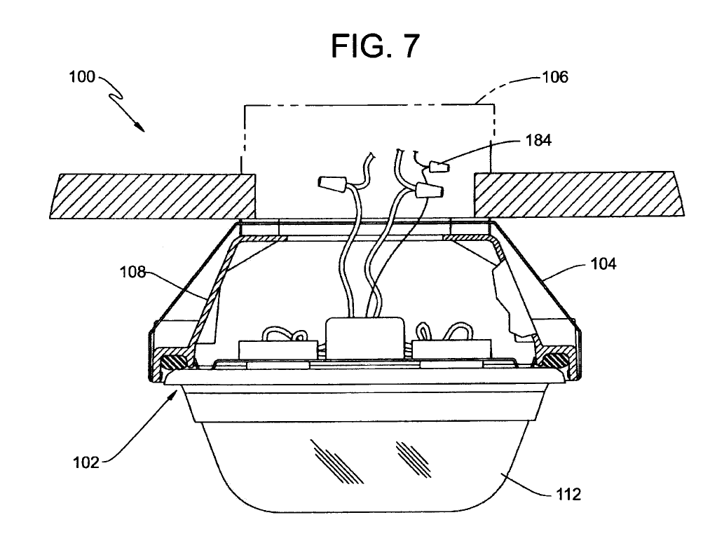

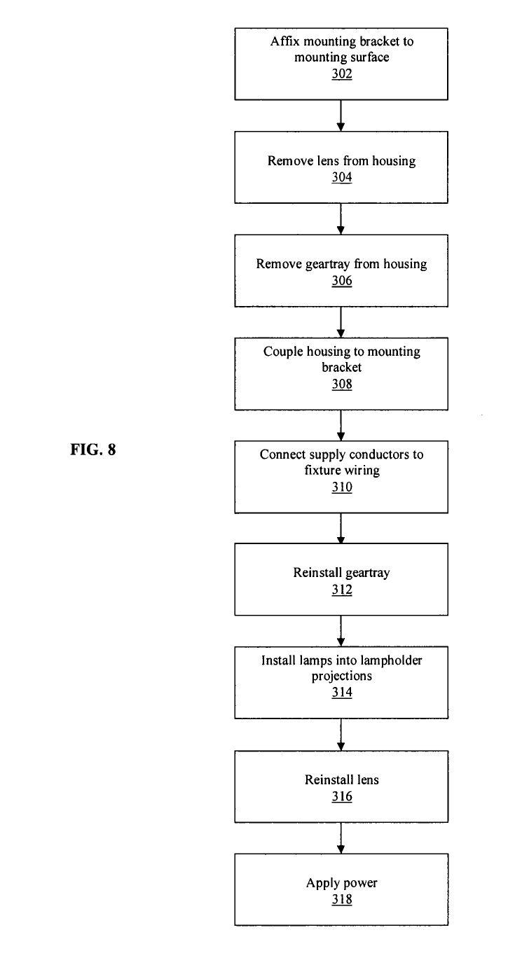

In operation, referring generally to FIGS. 1 and 5-8, the lighting system installation is done in a direction relatively orthogonal to the mounting surface, for example, along axis A of FIG. 1

At a step 302, mounting bracket 104 is affixed to the mounting surface. Mounting bracket 104 is positioned directly under recessed junction box 106 where lighting fixture 102 is to be installed. Using coupling apertures 160 as a template, one or more fasteners 180 are secured through coupling apertures 160 to secure mounting bracket 104 to the mounting surface. In an embodiment, at least two fasteners 180 are used, with one fastener 180 positioned through main surface 152 at an area proximate a first set of mounting bracket clips 154, and a second fastener 180 positioned through main surface 152 at an area proximate a second set of mounting bracket clips 154. In an embodiment, washers contact main surface 152 to provide more coverage area to each fastener 180 than the fastener head. In another embodiment, three or more fasteners 180 are utilized. Mounting bracket 104 is thus operably coupled to the mounting surface, for example, as depicted in FIG. 5.

At a step 304, lens 112 is then removed from housing 108 by unsnapping lens 112 from housing 108. In another embodiment, lens 112 is removed from housing 108 by opening or unsnapping latches located on the side of housing 108.

At a step 306, geartray 110 is removed from housing 108 by operation of retaining clips 122. Specifically, in an embodiment, retaining clips 122 are squeezed together on the top of geartray 110 to free geartray 110 from housing 108. In an embodiment, a first set of retaining clips 122 are squeezed together to free one side of geartray 110, then a second set of retaining clips 122 are squeezed together to free the opposite side of geartray 110. Geartray 110 can then be rotated backwards to expose ballast 140 and fixture wiring 142

At a step 308, housing 108 is coupled to mounting bracket 104. Housing 108 is positioned such that it is centered on mounting bracket 104. In an embodiment, housing 108 is centered such that mounting bracket clips 154 are positioned just inside latch-mounting members 130 located on the sides of housing 108. Housing 108 is pushed into mounting bracket 104, and specifically, main surface 152. In an embodiment, housing 108 can be secured in mounting bracket 104 by pushing first elongated sidewall 116a and elongated body 114 into a pair of mounting bracket clips 154—a first mounting bracket clip 154 positioned along the first elongated side at a location proximate the first abbreviated side and second mounting bracket clip 154 positioned along the first elongated side at a location proximate the second abbreviated side. Specifically, the angle created by first elongated sidewall 116a and elongated body 114 is aligned to angle of projection 170. Correspondingly, first portion 166 of leg 162 is aligned to first elongated sidewall 116a and second portion 168 is aligned to lip 120. Hook 164 secures the portion of lip 120 coupled to first elongated sidewall 116a. Angle of projection 170 and angle of extension 172, combined with hook 164 and the extension of first portion 166, and the extension of second portion 168 of leg 162 provide resilient engagement of housing 108.

Housing 108 can be slightly rotated to push second elongated sidewall 116b and elongated body 114 toward main surface 152 until second elongated sidewall 116b and the portion of lip 120 coupled to second elongated sidewall 116b snaps into a second pair of mounting bracket clips 154. As the respective hooks 164 of the second set of mounting bracket clips 154 secures second elongated sidewall 116b, the angle created by second elongated sidewall 116b and elongated body 114 is aligned to the respective angle of projection 170 of the second set of mounting bracket clips 154. Likewise, first portion 166 of leg 162 is aligned to second elongated sidewall 116b and second portion 168 is aligned to lip 120. Gasket 156 and bumpers 178 are compressed and provide a sealed interface to housing 108.

Geartray 110 can then be operably coupled to housing 108 via optional tether on geartray 110, and alignment tab 128, in an embodiment.

At a step 310, supply conductors 184 are connected to fixture wiring 142. Supply conductors 184 are fed from junction box 106 through mounting bracket 104 via wiring aperture 158 and through housing 108 via access aperture 124. Supply conductors 184 can then be operably coupled to fixture wiring 142. In an embodiment, supply conductors 184 are connected directly to fixture wiring 142 comprising a luminaire disconnect. In embodiments, the optional tether holds geartray 110 near housing 108 so as to not overextend fixture wiring 110, ballast 140, or junction box supply conductors 184.

At a step 312, geartray 110 is reinstalled into housing 108. Geartray 110 is repositioned to align with retaining clips 122. Once so positioned, geartray 110 can be pushed towards housing 108 until it snaps into a locked position.

At a step 314, one or more lamps 113 can then be operably coupled to one or more lampholder projections 138 into a final lighting configuration within lighting fixture 102.

At a step 316, lens 112 can be snapped back into housing 108. In another embodiment, latches can be re-snapped or re-secured to reinstall lens 112.

Finally, at step 318, power can be applied to one or more lamps 113 via supply conductors 184, ballast 140, and fixture wiring 140 to illuminate lighting fixture 102.

Referring to the embodiment of FIG. 4 and lighting system 200, mounting bracket 104 is installed as described above, but lighting fixture 202 is positioned such that housing 208, and specifically, wiring aperture 258 is aligned with junction box 206.

Further, supplemental mounting bracket 204 is positioned in line with mounting bracket 104, as shown in FIG. 4 to provide support for the end of lighting fixture 202 distal the end coupled to mounting bracket 104. As such, subsequent to step 302, supplemental mounting bracket 204 is affixed to the mounting surface. Referring to FIG. 6, using coupling apertures 260 as a template, one or more fasteners 280 are secured through coupling apertures 260 to secure mounting bracket 204, and specifically, main surface 252 to the mounting surface. In an embodiment, one fastener 280 is utilized, although main surface 252 provides for additional fasteners 280. Installation can then proceed as described above, with the installer aligning housing 208 into both mounting bracket 104 and supplemental mounting bracket 204.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A mounting bracket for mounting a light fixture to a support surface with at least one attachment element, a junction box being proximate said support surface and comprising electrical wires, the light fixture including a light fixture housing presenting a longitudinal axis and a light fixture lens, the mounting bracket comprising:
a mounting plate presenting a mounting plate main surface adapted for abutting relationship with said support surface, said mounting plate including structure defining a junction box aperture for access to said junction box, and said mounting plate further including structure defining at least one attachment element receiving aperture;
at least one pair of spaced apart, opposing mounting bracket clips carried by said mounting plate and adapted for snapably engaging said light fixture housing; and
a ring gasket operably coupled to said mounting plate main surface and oriented to surround said junction box aperture in watertight relationship,
wherein said electrical wires can be connected to said light fixture with said mounting bracket main surface secured in abutting relationship to said support surface by said attachment element, said ring gasket providing for the watertight passing of said electrical wires from said junction box into said light fixture.

2. The mounting bracket of claim 1, each of the mounting bracket clips further comprising:
a first bracket clip portion oriented at an angle of extension from said mounting plate main surface;
a second bracket clip portion oriented at an angle of extension from first bracket clip portion, wherein the angles of projection and extension provide positive, resilient engagement of said light fixture housing by said mounting bracket; and
a hook located at a distal end of the mounting bracket clip that extends back towards said mounting plate main surface.

3. The mounting bracket of claim 1, further comprising one or more supporting gaskets positioned along said main surface, wherein said one or more supporting gaskets further enable the watertight passing of said electrical wires from said junction box into said light fixture by providing uniform compression of said main surface with said lighting fixture housing.

4. The mounting bracket of claim 3, wherein said one or more supporting gaskets are circular.

5. The mounting bracket of claim 1, wherein said ring gasket is a substantially rectangular gasket.

6. The mounting bracket of claim 1, wherein said light fixture housing presents an angle of attachment between an elongated body extending along said longitudinal axis and a light fixture housing sidewall, and said angle of projection is about equal to said angle of attachment.

7. The mounting bracket of claim 5, wherein said light fixture housing presents a sidewall angle of a light fixture housing sidewall, and said angle of extension is about equal to said sidewall angle.

8. The mounting bracket of claim 1, further comprising a second pair of spaced apart, opposing mounting bracket clips carried by said mounting plate.

9. The mounting bracket of claim 8, further comprising a supporting member carried by said mounting plate operably coupling a single mounting bracket clip of the first pair of mounting bracket clips and a single mounting bracket clip of the second pair of mounting bracket clips.

10. The mounting bracket of claim 9, wherein said mounting bracket presents an angle of connection between said supporting member and a single mounting bracket clip, wherein said angle of connection further provides positive, resilient engagement of said light fixture housing by said mounting bracket.

11. A lighting system for illuminating a wet environment, the lighting system comprising:
a junction box including one or more supply conductors adapted to provide electrical power to the lighting system, the junction box recessed relative to a support surface;
a lighting fixture including—
a lighting fixture housing presenting a longitudinal axis,
a geartray operably coupled to the lighting fixture housing presenting one or more lampholder projections,
a lighting fixture lens operably coupled to the lighting fixture housing, and
one or more lamps operably coupled to one or more lampholder projections; and
a mounting bracket including—
a mounting plate presenting a mounting plate main surface configured to interface to the lighting fixture housing along the longitudinal axis, the mounting plate main surface including structure defining a junction box aperture for access to said junction box and the one or more supply conductors,
at least one pair of spaced apart, opposing mounting bracket clips carried by said mounting plate and adapted for snapably engaging said light fixture housing, and
a ring gasket operably coupled to said mounting plate main surface and oriented to surround said junction box aperture in watertight relationship.

12. The lighting system of claim 11, wherein the mounting bracket further comprises one or more supporting gaskets positioned along the mounting plate main surface to provide uniform compression of the mounting plate main surface with the lighting fixture housing.

13. The mounting bracket of claim 11, wherein the ring gasket is a substantially rectangular gasket.

14. The lighting system of claim 11, further comprising a supplemental mounting bracket comprising:
a supplemental bracket mounting plate presenting a supplemental bracket mounting plate main surface adapted for abutting relationship with the support surface, the supplemental bracket mounting plate main surface including structure defining at least one attachment element receiving aperture; and
at least one pair of spaced apart, opposing supplemental bracket mounting bracket clips carried by said supplemental bracket mounting plate and adapted for snapably engaging said light fixture housing.

15. The lighting system of claim 14, each of the supplemental bracket mounting bracket clips further comprising:
a supplemental bracket first bracket clip portion oriented at a supplemental bracket angle of extension from said supplemental bracket mounting plate main surface;
a supplemental bracket second bracket clip portion oriented at a supplemental bracket angle of extension from supplemental bracket first bracket clip portion, wherein the supplemental bracket angles of projection and extension provide positive, resilient engagement of said light fixture housing by said supplemental bracket; and
a hook located at a distal end of the supplemental bracket mounting bracket clip that extends back towards said supplemental bracket mounting plate main surface.

16. The lighting system of claim 15, wherein the supplemental mounting bracket further comprises one or more supplemental bracket supporting gaskets positioned along the supplemental bracket mounting plate main surface to provide uniform compression of the supplemental bracket mounting plate main surface with the lighting fixture housing.

17. The mounting bracket of claim 14, wherein the light fixture housing presents an angle of attachment between an elongated body extending along the longitudinal axis and a light fixture housing sidewall, and the supplemental bracket angle of projection is about equal to the angle of attachment.

18. The mounting bracket of claim 17, wherein the light fixture housing presents a sidewall angle of a light fixture housing sidewall, and the supplemental bracket angle of extension is about equal to the sidewall angle.

19. A method of installing a lighting system to a mounting surface, the lighting system including a junction box having one or more supply conductors being proximate the mounting surface, a lighting fixture including a lighting fixture housing presenting a longitudinal axis, a geartray operably coupleable to the lighting fixture housing presenting one or more lampholder projections and including fixture wiring, a lighting fixture lens operably coupleable to the lighting fixture housing, and one or more lamps, and a mounting plate presenting a mounting plate main surface adapted for abutting relationship with said support surface, said mounting plate including structure defining a junction box aperture for access to said junction box, and said mounting plate further including structure defining at least one attachment element receiving aperture, at least one pair of spaced apart, opposing mounting bracket clips carried by said mounting plate and adapted for snapably engaging said light fixture housing, and a ring gasket operably coupled to said mounting plate main surface and oriented to surround said junction box aperture in watertight relationship, the method comprising:
operably coupling the mounting bracket mounting plate main surface to the mounting surface, wherein the junction box aperture is aligned with the junction box;
operably coupling the lighting fixture housing to the mounting bracket by—
aligning the longitudinal axis of the lighting fixture housing with the mounting plate main surface,
aligning the at least one pair of spaced apart, opposing mounting bracket clips to the lighting fixture housing, and
easing the lighting fixture housing toward the mounting bracket until the at least one pair of spaced apart, opposing mounting bracket clips are operably coupled to the lighting fixture housing and the ring gasket is compressed;
connecting the one or more supply conductors to the fixture wiring;
operably coupling the geartray to the lighting fixture housing;
operably coupling the one or more lamps to one or more lampholder projections; and
operably coupling the lighting fixture lens to the lighting fixture housing.

20. The method of claim 19, further comprising removing the lens from the lighting fixture housing and removing the geartray from the lighting fixture housing prior to operably coupling the lighting fixture housing to the mounting bracket.

21. The method of claim 19, further comprising applying power to the one or more lamps by conducting electricity to the supply conductors.
